(19) United States
(12) Patent Application Publication
(10) Pub. No.: US 2003/0028390 A1
(43) Pub. Date: Feb. 6, 2003

(54) System to provide context-based services

(76) Inventors: Edith H. Stern, Yorktown Heights, NY (US); Barry E. Willner, Briarcliff Manor, NY (US); Philip Shi-lung Yu, Chappaqua, NY (US); David P. Greene, Ossining, NY (US); John J. Turek, South Nyack, NY (US)

Correspondence Address: BUCKLEY, MASCHOFF, TALWALKAR, & ALLISON, 5 ELM STREET, NEW CANAAN, CT, 06840, US

(21) Appl. No.: 09/919,328

(22) Filed: Jul. 31, 2001

(51) Int. Cl. G06F 17/60

(52) U.S. Cl. 705/1

(57) ABSTRACT

A system is provided in which first data associated with a user and owned by a first data owner is received, second data associated with the user and owned by a second data owner is received, and a service to provide to the user is determined based on the first data and the second data. As a result, a seller may spontaneously offer an appropriate service to a user, thereby increasing both the user's satisfaction with the seller and the seller's chance of profit.

### BACKGROUND OF THE INVENTION

1. Field of the Invention

The present invention relates to systems to enable the provision of context-based services to users. In particular, the present invention concerns a system to determine a service to provide to a user based on data associated with the user but owned by different data owners.

2. Description of the Related Art

Typically, a seller has the option to provide a single product to a user in several different manners. For example, a seller may provide a software application to a user via various postal delivery methods or electronic communication channels. The seller may also have the option to provide any of several versions of the software application to the user. Specifically, a seller may provide a user having certain hardware capabilities with a version of the application that is different from a version provided to a user having lesser hardware capabilities. Moreover, the application may be provided to one or more of multiple locations or multiple devices operated by the user. As is evident from the foregoing, many factors may be considered in determining a manner in which to provide a product to a user.

The term “service” will be used herein to include a product as well as a manner in which the product is to be provided to a user. Accordingly, a product to be provided to a user in a first manner will be considered one service and the same product to be provided to the user in a second manner will be considered a second service. Similarly, a first product to be provided to a user in one manner and a second product to be provided to the user in the same manner are considered different services. As discussed in the previous paragraph, manners in which a product may be provided may differ in one or more aspects, including product version, delivery method, and delivery location.

In order to provide an appropriate service to a user, conventional sellers simply require the user to order the appropriate service. For example, a user is required to order a version of a product and a delivery method appropriate to her capabilities and needs. This system is quite inefficient and often results in returned orders. Worse yet for the seller, the system may discourage a user from placing an order for fear of ordering an inappropriate service.

According to another conventional system, all users are simply provided with a same service. This service is usually a service requiring the fewest user capabilities, i.e., a “least-common denominator” service. Accordingly, the provided service is not optimal for many users.

Sellers have implemented several techniques in an attempt to address the foregoing problems. First, a seller of a particular service may present specifications to a user that define an environment for which the particular service is appropriate. Like the conventional systems discussed above, this technique unacceptably relies on the user to evaluate her environment and to select an appropriate service. Also similarly to the conventional systems, the technique requires a user to inquire about the particular service before the specifications are presented to the user.

Other sellers attempt to address these problems by detecting user information and by providing a service to a user based on the information. As an example, a Web browser executing in a user's computer may detect that the user has not installed a browser plug-in that is necessary to interpret a received Web page. Accordingly, the Web browser provides a service to the user including download and installation of the browser plug-in. Although this technique may be advantageous in a few simple situations, it is not suitable for situations in which many disparate factors are required to determine an appropriate service to provide to a user. As a result, some complex services cannot be offered using this technique.

In view of the foregoing, what is needed is a system for efficiently determining appropriate services to provide to users.

### SUMMARY OF THE INVENTION

The present invention relates to a system, means, method and medium to provide services in which first data associated with a user and owned by a first data owner is received, second data associated with the user and owned by a second data owner is received, and a service to provide to the user is determined based on the first data and the second data. By virtue of the foregoing, a seller may efficiently determine an appropriate service to provide to a user. As a result, the user may be more satisfied with the provided service than with services provided by previous systems. Moreover, the invention may enable a seller to spontaneously offer an appropriate service to a user, thereby increasing both the user's satisfaction with the seller and the seller's chance of profit.

In another aspect, the present invention concerns a system, means, method and medium to determine a user state in which first data associated with a user and owned by a first data owner is received, second data associated with the user and owned by a second data owner is received, a state is determined based on the first data and the second data, and the user is identified to a third party if the state corresponds to a target state. According to this aspect, a context aggregator can identify desirable users to a service provider. In an additional aspect, the service provider remits payment to the context aggregator in exchange for the identification.

With these and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a flow diagram of process steps to determine a service according to some embodiments of the present invention.

FIG. 2 is a topographic view of a network architecture according to some embodiments of the present invention.

FIG. 3 is a block diagram of an internal architecture of a provider server according to some embodiments to the present invention.

FIG. 4 is a block diagram of an internal architecture of a user device according to some embodiments to the present invention.

FIG. 5 is a representative view of a tabular portion of a user information database according to some embodiments of the present invention.

FIG. 6 is a representative view of a tabular portion of a service database according to some embodiments of the present invention.

FIG. 7 is a flow diagram of process steps to determine and to provide a service to a user according to some embodiments of the present invention.

### DETAILED DESCRIPTION

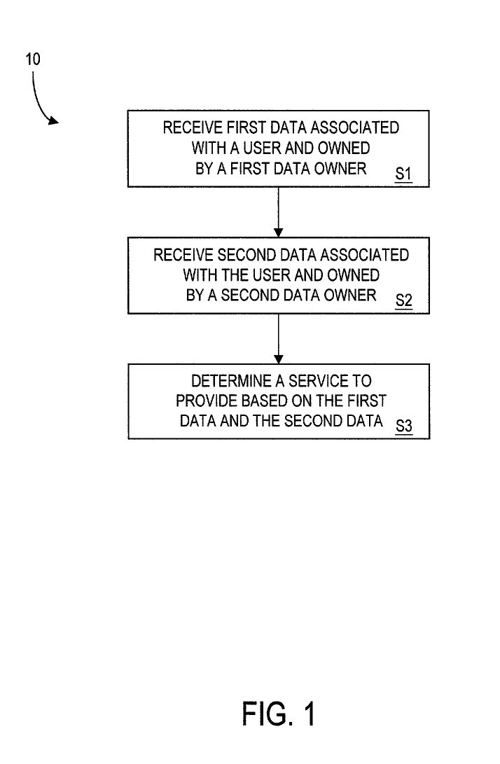

FIG. 1 is a flow diagram of process steps 10 to determine a service to provide according to some embodiments of the present invention. In order to provide an immediate introduction to features of the present invention, process steps 10 will be described without reference to a particular embodiment. Of course, a complete description of specific hardware and software embodiments of the claimed invention is set forth below.

Initially, first data associated with a user is received in step S1. The first data is owned by a first data owner. A data owner as described herein includes any entity that possesses control over access to data and/or modification of the data. Such entities include a user, a group of users, a business, and a group of businesses. In a case that each of several company employees uses a networked application such as a company calendar, each employee is considered an owner of the portion of the calendar data that he controls. Of course, several data owners may own a single piece of data. In the previous example, the company employing the employees may be considered an owner of all the calendar data.

Second data associated with the user is received in step S2. The second data is owned by a second data owner. It should be noted that either of the data received in step S1 and step S2 may be received in response to a request for data, according to a predetermined schedule, or otherwise. The data may also be received from different or identical sources.

In some embodiments, the first data and the second data describe a user context. More particularly, the data define certain aspects of an environment in which the user is or will be interacting. As such, the data may describe aspects of the user's past, current or future location, schedule, hardware devices, available software applications, available communication channels, or the like.

In step S3, a service to provide to the user is determined based on the first data and the second data. Because the first data and the second data are owned by different owners, the determination may incorporate factors not considered by previous systems. As a result, the determined service may be more appropriate to the user than those determined using the previous systems.

In one specific example of process steps 10, the first data is received from a user device and indicates software applications that were used by the user when last operating the user device as well as the last states of those applications. The states may comprise information such as the identity of opened files, displayed toolbars, or the like. The second data is received from a network provider and indicates that the user has turned on a Personal Digital Assistant (PDA) and logged on to the network. Accordingly, in step S3, it is determined to provide the user with a service that will open, on the PDA, each of the previously-used software applications in their respective last states. This service would allow the user to move from one user device to another while minimizing any interruption in workflow.

It should be noted that the service may also be determined in step S3 based on additional information which is not associated with the user, such as weather, traffic patterns, or the like. For example, the received first data may include data from a corporate calendar specifying a time and location of a meeting and the second data may include data received from a cellular network provider specifying the user's location and the user's cellular telephone number. Using the first and second data, as well as data indicating current traffic patterns, it is determined to provide particular directions to the user. The directions may be provided using the cellular telephone number. Notably, the service may be provided asynchronously or in response to a request from the user.

In this regard, it should also be noted that each of process steps 10 may be performed asynchronously. For example, data associated with users may be constantly received and analyzed to determine services to provide to the users.

Network Architecture

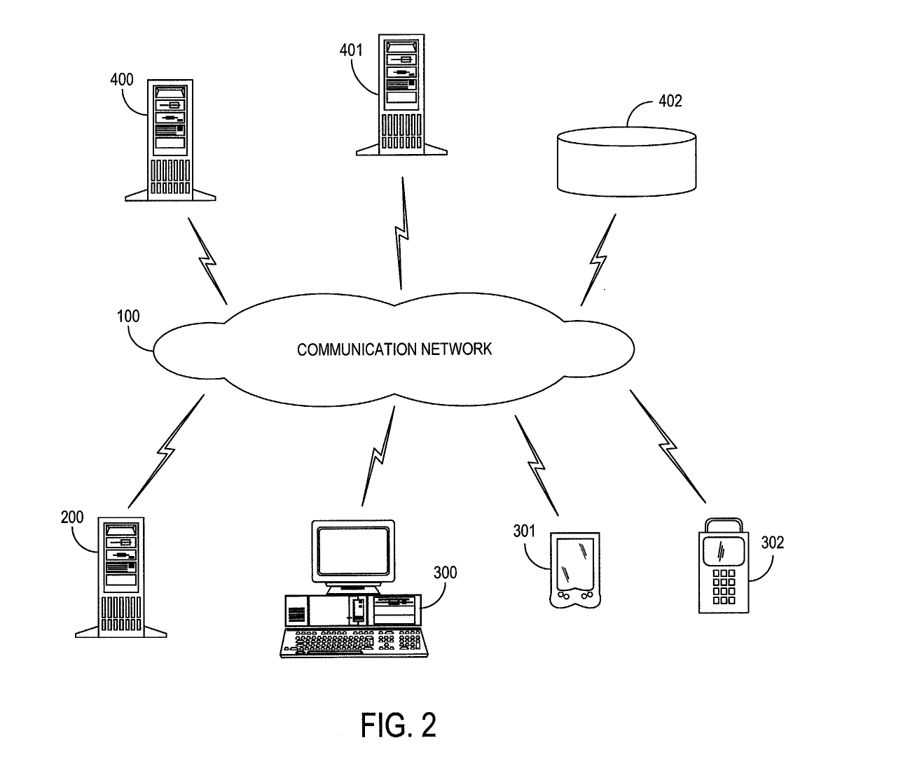

FIG. 2 is a topographic view of a network architecture according to some embodiments of the present invention. Of course, network architectures other that that shown in FIG. 2 may be used to implement the invention.

FIG. 2 shows communication network 100 in communication with provider server 200, user devices 300 to 302, and data sources 400 through 402. Communication network 100 may comprise any number of systems for transferring data, including a local area network, a wide area network, a telephone network, a cellular network, a fiber-optic network, a satellite network, an infra-red network, a radio frequency network, and any other type of network that may be used to transmit information between devices. Additionally, communication network 100 may be used to transmit data using any known transmission protocol, such as Asynchronous Transfer Mode (ATM), Internet Protocol (IP), Hypertext Transfer Protocol (HTTP) and Wireless Application Protocol (WAP). In one embodiment, communication network 100 is the World Wide Web.

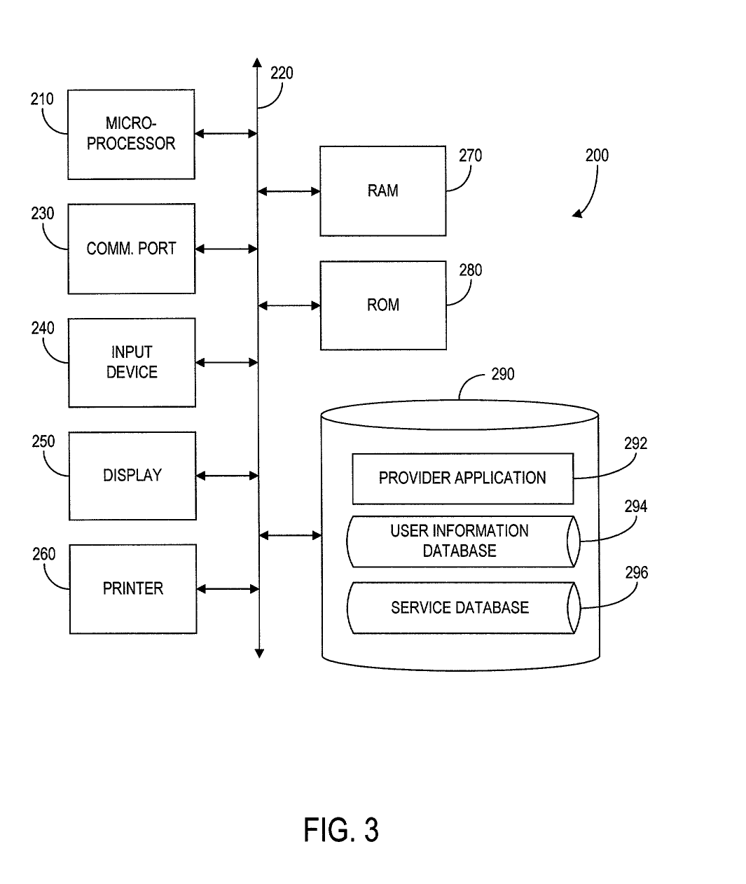

Provider server 200 may comprise a network server or another device capable of performing the functions attributed herein to provider server 200. For example, according to some embodiments, provider server 200 operates to receive first data associated with a user and owned by a first data owner, to receive second data associated with the user and owned by a second data owner, and to determine a service to provide based on the first data and the second data. In addition to these functions, provider server 200 may control various operations of a seller such as inventory management, requisitioning, billing and the like. Details of one embodiment of provider server 200 are set forth below with respect to FIG. 3.

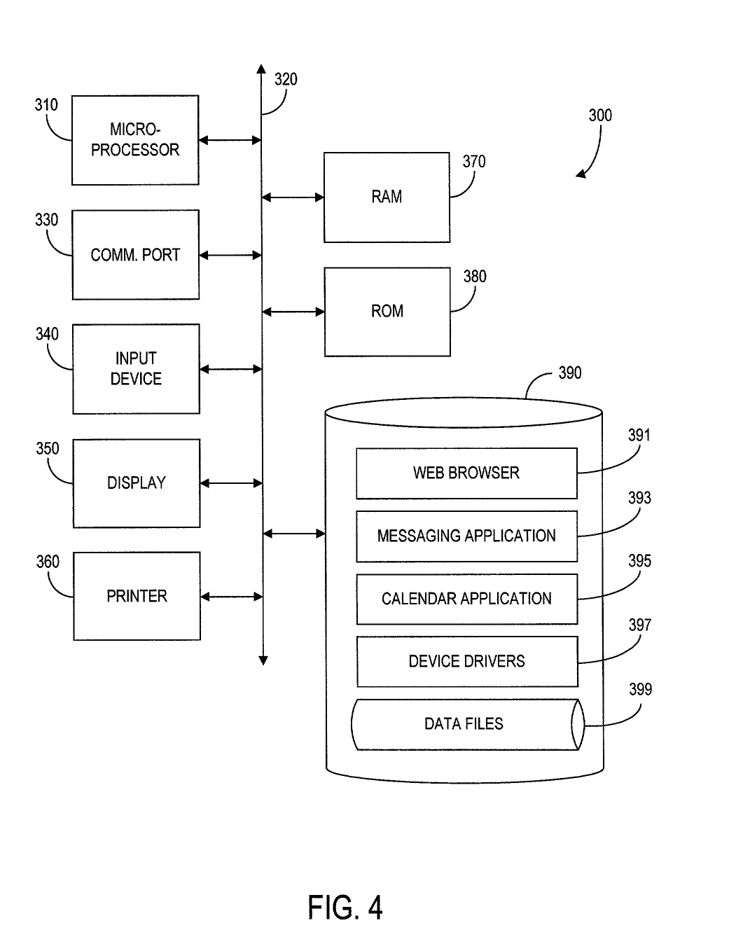

User devices 300 to 302 comprise a workstation, a PDA and a cellular telephone. Any of user devices 300 to 302 may be operated by a user to request services, to transmit data associated with the user, to receive offers for services determined according to the invention, and to receive services from provider server 200. Accordingly, any device or devices capable of transmitting and receiving information may be employed as a user device in accordance with the invention. In this regard, any of user devices 300 to 302 may be dedicated to providing functionality according to the present invention or may provide a user with other desired functions. FIG. 4 illustrates the internal architecture of a general-purpose version of user device 300.

Data sources 400 through 402 store context data used by provider server 200 to determine a service to provide to a user. Data sources 400 through 402 comprise a server, a server and a data repository, respectively, and may be operated by the entity operating provider server 200 or by an independent entity providing data services. The data stored in each of data sources 400 through 402 may be owned by one or more data owners.

A data source according to the present invention may comprise any system for storing and transmitting data. Such systems may be software-based, hardware-based or both, and may also include any entity previously defined as a data owner. Accordingly, contemplated data sources include an enterprise, a data carrier such as an IP network provider or a telephone network provider, a user, a website, a biometric device, an electronic calendar, an electronic task list, a messaging application, and a seller. It should be noted that a data source from which data is received by provider server 200 need not be the data source that originally created or detected the data.

Unlimited types of context data may be stored and/or provided by data sources 400 through 402. A non-exhaustive list of context data usable in accordance with the invention includes an application state, biometric data such as skin response data, facial gesture data and body temperature data, computer usage data, telephone usage data, a position in a corporate application, a position in a standard application, proximity data, a location, data related to an expected location, data usable to contact a user at the expected location, a network protocol, a connection state, a bandwidth, a data latency period, a request from a similar user, a previous request from the user, a cell ID, a fine location, a proximity to a data transmission service, user preferences, an emotional state, data related to another user associated with the user, a Web cookie, a last known state, data relating to similar users, permanent I/O capability, temporary I/O capability, screen size, screen refresh rate, communication type, battery data, data relating to peripheral devices, cookie information, an expected communication capability, expected travel time, a desired application, a user expected to be contacted, an expected purchase, natural language parsed content, an extracted expected location, a contact, keywords, a last purchase, a last time of purchase, news, weather, traffic, cultural data, educational data, and arts data. Such context data may be updated in real-time or per any other interval.

According to other embodiments, the elements of FIG. 2 are connected differently than as shown. For example, some or all of the elements may be connected directly to one another. Of course, embodiments of the invention may include elements that are different from those shown.

The devices shown in communication with each other might not be constantly exchanging data. Rather, communication may be established when necessary and severed at other times or always available but rarely used to transmit data. Moreover, although the illustrated communication links between the components of FIG. 2 appear dedicated, it should be noted that each of the links may be shared by other components.

Provider Server

FIG. 3 is a block diagram of the internal architecture of provider server 200 according to some embodiments of the invention. As illustrated, provider server 200 includes microprocessor 210 in communication with communication bus 220. Microprocessor 210 may be a Pentium™, RISC™-based, or other type of processor and is used to execute processor-executable process steps so as to control the components of provider server 200 to provide functionality according to embodiments of the present invention.

Also in communication with communication bus 220 is communication port 230. Communication port 230 is used to transmit data to and to receive data from devices external to provider server 200. Communication port 230 is therefore preferably configured with hardware suitable to physically interface with desired external devices and/or network connections. In some embodiments, first data and second data are received and services determined based thereon are offered over communication port 230.

Input device 240, display 250 and printer 260 are also in communication with communication bus 220. Any known input device may be used as input device 240, including a keyboard, mouse, touch pad, voice-recognition system, or any combination of these devices. Input device 240 may be used by an operator of provider server 200 to input information concerning available services, as well as associations between those services and context data. Of course, such information may also be input to provider server 200 via communication port 230.

Display 250 may output text and graphics to an operator of provider server 200 in response to commands issued by microprocessor 210, and may be an integral or separate CRT display, flat-panel display or the like. Printer 260 may also output text and graphics, but in hardcopy form using ink-jet, thermal, dot-matrix, laser, or other printing technologies.

RAM 270 is connected to communication bus 220 to provide microprocessor 210 with fast data storage and retrieval. In this regard, processor-executable process steps being executed by microprocessor 210 are typically stored temporarily in RAM 270 and executed therefrom by microprocessor 210. ROM 280, in contrast, provides storage from which data can be retrieved but to which data cannot be stored. Accordingly, ROM 280 is used to store invariant process steps and other data, such as basic input/output instructions and data used during system boot-up or to control communication port 230. It should be noted that one or both of RAM 270 and ROM 280 may communicate directly with microprocessor 210 instead of over communication bus 220.

Data storage device 290 stores provider application 292, user information database 294, and service database 296. Provider application 292 consists of processor-executable process steps executed by microprocessor 210 in order to control provider server 200 to determine a service in accordance with the present invention. More specifically, the process steps of provider server program 292 may be executed by microprocessor 210 to receive first data associated with a user and owned by a first data owner, to receive second data associated with the user and owned by a second data owner, and to determine a service to provide to the user based on the first data and the second data. As described above, these features enable a seller to efficiently offer an appropriate service to a user, thereby increasing both the user's satisfaction with the seller and the seller's likelihood of profit.

The process steps of provider application 292 may be read from a computer-readable medium, such as a floppy disk, a CD-ROM, a DVD-ROM, a Zip™ disk, a magnetic tape, or a signal encoding the process steps, and then stored in data storage device 290 in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

User information database 294 stores context data associated with users. The context data may be used to determine a service to provide to a user in accordance with the present invention. In a case that the entity operating provider server 200 is a context aggregator, the context data may also be sold to third parties interested in the context data of users who satisfy particular criteria, such as a particular demographic, a location, other criteria, or any combination of the foregoing. The context data may then be used by the third parties to determine services to provide to the users.

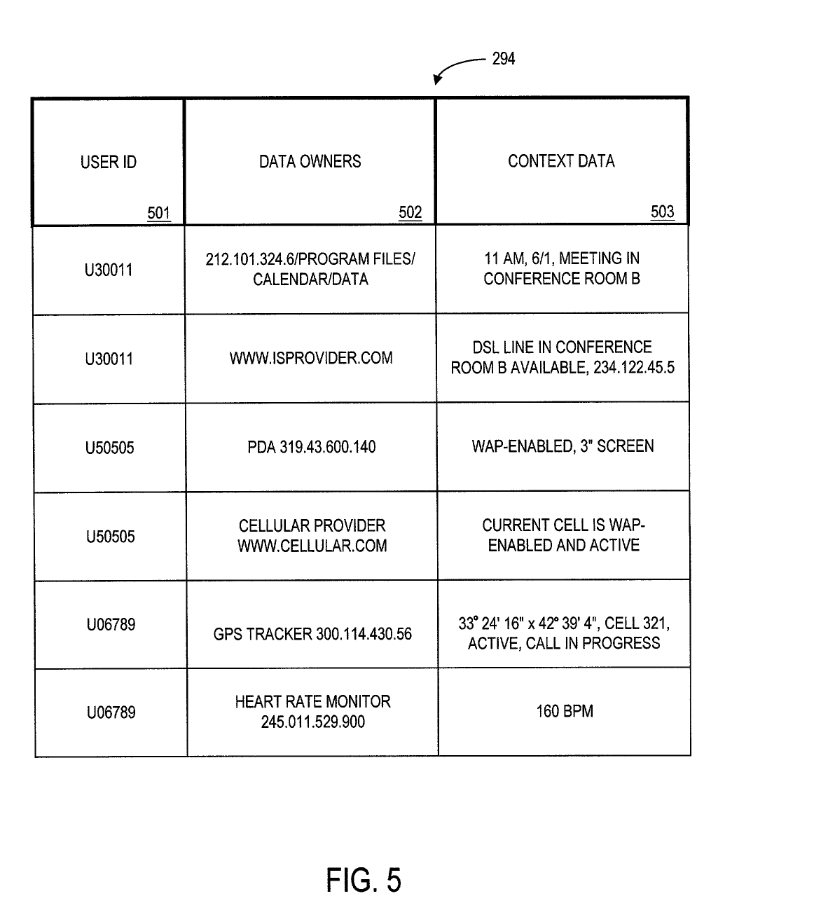

Also stored in user information database 294 may be information usable to retrieve data from data sources. It should be noted that any of data sources 400 through 402 and user device 300 may also store a data structure such as user information database 294, although the data contained therein may be different from that contained in user information database 294 of provider server 200. A specific example of a portion of user information database 294 will be described with respect to FIG. 5.

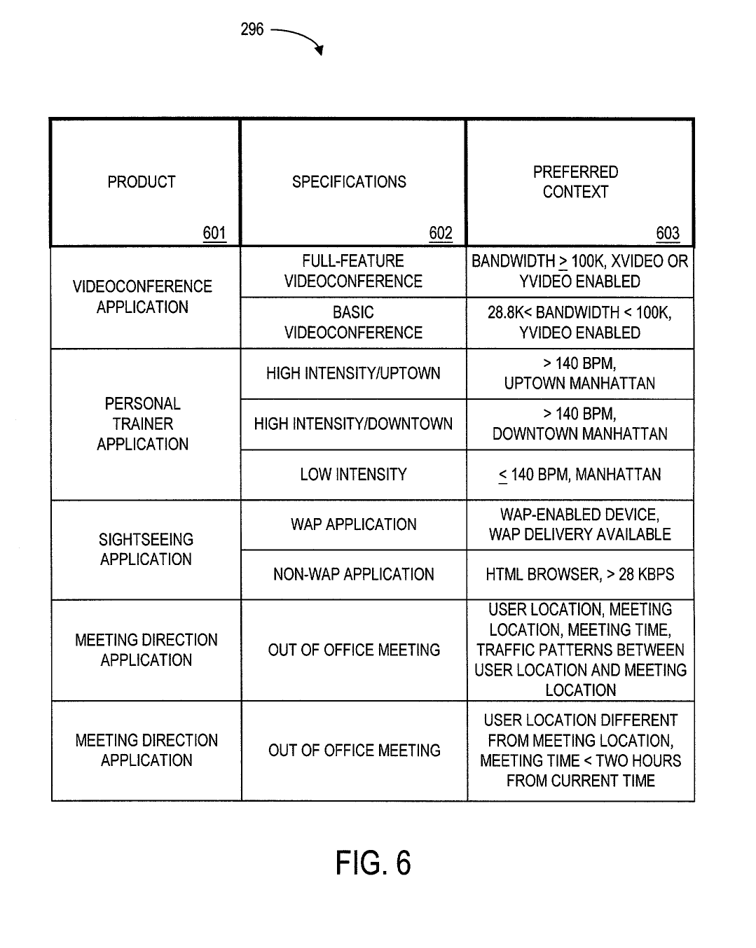

Service database 296 stores information relating to services that may be provided by provider server 200. The services reflected in service database 296 include, as defined above, a product as well as a details regarding a manner in which the product is to be provided to a user. Service database 296 also associates each service with a context for which the service is preferred. Accordingly, service database 296 may be used to determine a service based on context information, including first data and second data associated with a user. Service database 296 will be described in more detail below with reference to FIG. 6.

In some embodiments, data storage device 290 also stores other unshown elements that may be necessary for operation of provider server 200, such as other applications, other data files, an operating system, a database management system and “device drivers” for allowing microprocessor 210 to interface with devices in communication with communication port 230. These elements are known to those skilled in the art, and are therefore not described in detail herein.

User Device

FIG. 4 illustrates several components of user device 300 according to some embodiments of the invention. The components may comprise any of the specific examples set forth above with respect to identically-named components of provider server 200. Of course, specific functions performed by the components may differ from the functions performed by the identically-named components of provider server 200.

For example, microprocessor 310 may be used to execute processor-executable process steps to transmit first data and/or second data associated with a user to provider server 200 or to one of data sources 400 through 402. In this regard, communication port 330 may be used to transmit the data and to receive a service or an offer to provide the service, the service having been determined based on the first data and the second data. A user may use input device 340 to input the data, and the offer may be presented using display 350 and/or printer 360. Of course, each of these components may be used to provide other functionality to the user in accordance with other applications executed by user device 300.

Data storage device 390 stores processor-executable process steps of such applications. As shown, stored in data storage device 390 are processor-executable process steps of Web browser 391, messaging application 393, calendar application 395, and device drivers 397. The process steps of Web browser 391 may be executed by microprocessor 310 to allow user device 300 to send and receive information over the Web. More specifically, Web browser 391 allows user device 300 to transmit data to and to receive data from a device executing process steps of a Web server.

Process steps of messaging application 393 may be executed to provide various messaging services to a user, including instant messaging, intranet messaging, and Internet messaging. Calendar application 395 may include process steps executable to provide an electronic calendar, an electronic task list, electronic reminders or the like to the user. Calendar application 395 may be capable of integrating calendars, tasks and reminders of several associated users, such users in a same company, department, or family. Of course, messaging application 393 and calendar application 395 may be server-based and synchronized to user device 300.

Device drivers 397 are used to interface with devices in communication with communication bus 320, either directly or through an element such as communication port 330. In addition, data files 399 include data used in conjunction with the applications stored in data storage device 390, and may include first data and second data associated with a user. As described with respect to data storage device 290, data storage device 390 may also store other known elements that may be necessary for operation of user device 300.

The foregoing is an example of one embodiment of a user device according to the present invention. A user device according to the invention may be a much less specialized device than the foregoing, such as a standard cellular telephone. As an example of one service provided to this type of device, the telephone is called once the telephone enters a particular location and the answering user is played newly-received voice mail messages. In this use, the context data used to determine the service to provide specifies the location of the telephone (received from a cellular network provider) and the existence of new voice mail messages (received from a voice mail server).

User Information Database

A tabular representation of a portion of user information database 294 is shown in FIG. 5. The information stored in user information database 294 may be entered by an operator through input device 240 of provider server 200, or may be received from user device 300 or data sources 400 through 402 over communication port 230. As described above, user information database 294 may be used to determine a service to provide to a user in accordance with the present invention.

User information database 294 includes several records and associated fields. The fields include user ID field 501, data owners field 502, and context data field 503. Of course, user information database 294 may include many more records than those shown in FIG. 5 and each record may include fields other than those shown.

User ID field 501 of a particular record includes a code associated with a user. Accordingly, the remaining fields of the particular record include data associated with the user. The code may also be used in other databases to identify information associated with the user. For example, a contact database may store many such codes, with each code being associated with a set of contact information.

Data owners field 502 identifies owners of context data associated with the user. As shown, field 502 also provides information such as Web or IP addresses for obtaining data from the identified owners. The information stored in data owners field 502 may be obtained from an operator using input device 240, from responses to user questionnaires transmitted from user device 300, from software applications executing in user device 300, from data sources 400 through 402, and from the data owners themselves.

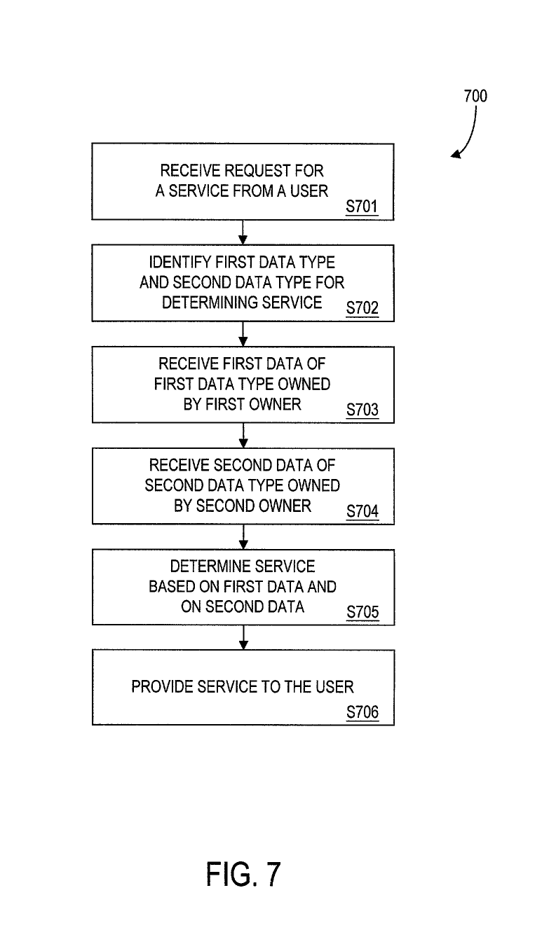

Stored in context data field 503 is context data associated with the user and obtained from the data owner specified in associated data owners field 502. The stored data may comprise any of the context data described above as defining an environment associated with a user. Accordingly, data such as that stored in context field 503 may be used to determine a service to provide to a user in accordance with the present invention. The stored context data may be updated periodically or in response to an event such as a request for context data from an associated data owner, or a change in user context data. Usage of context data field 503, as well as the other fields of user information database 294, will be described below with reference to FIG. 7.

Context data field 503 may also include user preference data. Such user preference data may specify that an associated user does not wish to receive any services determined according to the present invention, does not wish to receive any unsolicited advertisements, prefers to fill up her automobile gas tank when the tank is half full, will not purchase services from a particular company, or the like. As with all other context data described herein, user preference data may be used to determine a service to provide to a user according to the present invention.

Service Database

FIG. 6 illustrates a tabular representation of a portion of service database 296. Service database 296 stores information relating to services that may be provided by provider server 200. The stored information may be received from an operator of provider server through input device 240, from data sources 400 through 402, or from other sources.

As described above, a service comprises a product as well as a manner in which the product is to be provided to a user. Accordingly, the illustrated portion of service database 296 includes product field 601 and specifications field 602. Specifications field 602 specifies the manner in which a product specified in an associated product field 601 may be provided to a user. The specified manner may include a product version, a delivery method, a delivery location, and other product specifications. As a result, product field 601 and specifications field 602 of a record together specify a service according to some embodiments of the invention.

Preferred context field 603 of a particular record specifies context data associated with the particular record. The specified context data describes a context appropriate to the service reflected in the record. In other words, the specified context describes an environment that is preferred and/or required for delivery and/or use of the associated service. In some embodiments, a user context is determined based on first data and second data associated with a user, a record of service database 296 is identified in which preferred context field 603 matches the determined user context, and a service defined by product field 601 and specifications field 602 of the record is provided to the user. One embodiment of such a process is described in detail with respect to FIG. 7.

Preferred context field 603 may specify context information needed to provide a product specified in associated product field 601. For example, if a user requests a “meeting direction application”, the context information specified in associated preferred context field 603 is obtained and used to appropriately provide the meeting direction application. Alternatively, and as shown in FIG. 6, the meeting direction application may be offered to the user if associated context data shows that a meeting location is different from a user location and the meeting time is two hours from the current time.

As will be understood by those skilled in the art, the illustrations and accompanying descriptions of user information database 294 and service database 296 merely represent relationships between stored information. A number of other arrangements may be employed besides those suggested. Similarly, the illustrated fields and field values represent sample information only; those skilled in the art will understand that the amount and content of this information may be different from that illustrated.

Specific Example

FIG. 7 sets forth process steps 700 to offer context-based services according to some embodiments of the present invention. Process steps 700 are described herein as being included in provider application 292 and executed by provider server 200, however, it should be noted that various ones of the process steps may be included in other applications executed by any device or number of devices, and that some of process steps 700 may be performed manually.

Briefly, according to process steps 700, first data associated with a user and owned by a first data owner is received, second data associated with the user and owned by a second data owner is received, and a service to provide to the user is determined based on the first data and the second data. As a result, a seller may efficiently determine an appropriate service to provide to a user, the user may be more satisfied with the provided service than with services provided by previous systems, and the invention may enable a seller to spontaneously offer an appropriate service to a user, thereby increasing both the user's satisfaction with the seller and the seller's chance of profit.

Turning to the specific steps, a request to receive a service is received from a user in step S701. The request may be input by a user using input device 340 of user device 300, and received by Web browser 391. Web browser 391 transmits the request to provider server 200, which receives the request by executing process steps of a Web server included in provider application 292. In one example of step S701, a request for a sightseeing application is received from a user.

Next, in step S702, a first data type and a second data type are identified. In some embodiments, the identified data types are data types needed to determine a service to provide to the user in response to the received request. Continuing with the foregoing example, service database 296 is analyzed in step S702 to identify data types required to determine a service in which the product is a sightseeing application. More particularly, service database 296 is searched to identify all records in which product field 601 includes the product “sightseeing application”. Preferred context field 603 of each identified record is then analyzed to determine the data types represented therein. As shown, the represented data types include device data and delivery data. It should be noted that more than two data types may be identified in step S702. Moreover, according to the invention, the second data type need not be different from the first data type.

First data of a first identified data type is received in step S703. The received first data is associated with the user from whom the request was received in step S701, and is owned by a first data owner. User information database 294 may be used to receive the first data. For example, records of user information database 294 are identified in which user ID field 501 corresponds to the user. In this regard, received from the user in step S701 may be a user ID. Alternatively, received in step S701 may be other information from which a user ID may be determined using a database associating user IDs with other information, such as name, address, IP address, e-mail address, or the like.

Once the records are identified, first context data of the first data type is retrieved from one of the records. To illustrate, it is assumed that the user corresponds to user ID “U50505” and the first data type is device data. Accordingly, a record is located that is associated with user ID “U50505” and in which data owners field 502 identifies a device. As shown in FIG. 5, one record exists that is associated with user ID “U50505” and in which data owners field 502 identifies a device, specifically a PDA. The first context data, “WAP-enabled, 3″ screen” is then retrieved from context data field 503 associated with the located record.

In other embodiments, the data stored in data owners field 502 is used to retrieve the first context data directly from the data owner. For example, an IP address stored in data owners field 502 may be used to retrieve context data associated with the address. Such an arrangement facilitates the retrieval of current context data.

Second data of a second data type and owned by a second owner is retrieved in step S704. Step S704 may proceed similarly to step S703. Returning to the example, the record of user information database 294 that is associated with user ID “U50505” and identifies a delivery provider in data owners field 502 is located. Accordingly, the second data, “current cell is WAP-enabled”, is retrieved from context data field 503 of the located record.

Next, in step S705, a service is determined based on the received first data and second data. In some embodiments the service is determined by identifying a service associated with a preferred context that is satisfied by the first data and the second data. More particularly, service database 296 is analyzed to identify a record in which preferred context field 603 specifies a context that is described by the first data and the second data. Accordingly, the data stored in product field 601 and specifications field 602 of the record defines the service determined in step S705. Based on service database 296 and on the first data and the second data received according to the above example, the service determined in step S705 is a sightseeing application delivered in WAP format. Next, in step S706, the service is provided to the user.

By virtue of the foregoing, an appropriate service may be determined and provided to a user. Of course, such a service may be determined without receiving a request from a user. That is, a service may be offered to a user or provided to the user simply based on first data associated with the user and owned by a first owner and second data associated with the user and owned by a second owner.

In other embodiments, the service is offered to the user in step S706 and, if the user accepts the offer, the service is provided to the user. It should be noted that, in these embodiments, the service may be provided by an entity different from the entity performing process steps 700.

In still other embodiments, the determined service and the user are identified in step S706 to a service provider. The service provider may then offer and/or provide the service to the user at its discretion. Such embodiments are useful in a case that process steps 700 are performed by a context aggregator. In this regard, a user may be more willing to allow a context aggregator, rather than a service provider, to receive associated context data.

Process steps 700 may be altered to create embodiments of the invention according to any of the alternative arrangements mentioned or suggested herein. Moreover, although the present invention has been described with respect to particular embodiments and alternative arrangements thereof, those skilled in the art will note that various substitutions may be made to those embodiments and arrangements without departing from the spirit and scope of the present invention.

What is claimed is:

1. A method for providing a service, comprising:
receiving first data associated with a user and owned by a first data owner;
receiving second data associated with the user and owned by a second data owner; and
determining a service to provide to the user based on the first data and the second data.

2. A method according to claim 1, further comprising:
providing the service to the user.

3. A method according to claim 1, wherein the first data is received from a first source and the second data is received from a second source, and wherein at least one of the first source and the second source comprises at least one of: an enterprise; a data carrier; a user; a website; a biometric device; an electronic calendar; an electronic task list; a messaging application; and a seller.

4. A method according to claim 1, wherein at least one of the first data and the second data comprises: an application state; biometric data; computer usage data; telephone usage data; a position in a corporate application; a position in a standard application; and proximity data.

5. A method according to claim 1, wherein at least one of the first data and the second data comprise data related to an expected location.

6. A method according to claim 5, wherein the expected location is based on an electronic calendar.

7. A method according to claim 5, wherein the data related to the expected location includes data usable to contact a user at the expected location.

8. A method according to claim 5, wherein the data related to the expected location comprises real-time data.

9. A method according to claim 1, wherein at least one of the first data and the second data comprises at least one of: a location; a network protocol; a connection state; a bandwidth; a data latency period; a proximity; a request from a similar user; and a previous request from the user.

10. A method according to claim 9, wherein the location comprises at least one of: a cell ID; a fine location; and a proximity.

11. A method according to claim 10, wherein the proximity indicates a proximity to a data transmission service.

12. A method according to claim 1, wherein at least one of the first data and the second data comprises at least one of: user preferences; an emotional state; and data related to another user associated with the user.

13. A method according to claim 1, wherein at least one of the first data and the second data comprises at least one of: a Web cookie; a last known state; and data relating to similar users.

14. A method according to claim 1, wherein at least one of the first data and the second data comprises at least one of: skin response data, facial gesture data; and body temperature data.

15. A method according to claim 1, wherein at least one of the first data and the second data comprises at least one of: permanent I/O capability; temporary I/O capability; bandwidth; screen size; computer usage data; screen refresh rate; communication type; battery data; data relating to peripheral devices; an application state; and cookie information.

16. A method according to claim 1, wherein at least one of the first data and the second data comprises at least one of: an expected location; an expected communication capability; and expected travel time.

17. A method according to claim 1, wherein at least one of the first data and the second data comprises at least one of: a desired application; an expected location; a user expected to be contacted; and an expected purchase.

18. A method according to claim 1, wherein at least one of the first data and the second data comprises at least one of: natural language parsed content; an extracted expected location; a contact; an application state; and keywords.

19. A method according to claim 1, wherein at least one of the first data and the second data comprises at least one of: a last purchase; a last time of purchase; and a location.

20. A method according to claim 1, wherein at least one of the first data and the second data comprises data unrelated to the user.

21. A method according to claim 20, wherein the data unrelated to the user comprises at least one of: news; weather; traffic; cultural data; educational data; and arts data.

22. A method according to claim 1, wherein at least one of the first data and the second data comprises data associated with a second user associated with the user.

23. A method according to claim 1, further comprising:
receiving a payment from the user in exchange for the service.

24. A method according to claim 1, further comprising:
receiving a payment from a seller of the service.

25. A method according to claim 1, wherein the service comprises advertising.

26. A method according to claim 1, wherein the service comprises an offer to sell.

27. A method according to claim 1, further comprising:
receiving an indication that the user does not want to receive services determined based on the first data and the second data.

28. A method according to claim 1, further comprising:
determining a state based on the first data and the second data.

29. A method according to claim 28, wherein the state comprises at least one of: busy; available; available hands free; available eyes free; available hands and eyes free; full; and emotional states.

30. A method according to claim 28, further comprising: identifying the users to a third party if the state corresponds to a target state.

31. A method according to claim 30, further comprising:
receiving a payment from the third party in exchange for the identification.

32. A method according to claim 1, wherein at least one of the first data and the second data is received via at least one of: a push protocol; a pull protocol; a broadcast; and a native observation.

33. A method according to claim 1, further comprising:
transmitting an alert based on the first data and the second data.

34. A method according to claim 33, wherein the alert indicates that a state of the user is different from a target state.

35. A method according to claim 33, wherein at least one of the first data and the second data is received via at least one of: a wireless protocol; a wire-line protocol; and a packet e-mail protocol.

36. A method according to claim 1, further comprising:
receiving a service request from the user.

37. A method to determine a user state, comprising:
receiving first data associated with a user and owned by a first data owner;
receiving second data associated with the user and owned by a second data owner;
determining a state based on the first data and the second data; and
identifying the user to a third party if the state corresponds to a target state.

38. A method according to claim 37, wherein the first data is received from a first source and the second data is received from a second source, and wherein at least one of the first source and the second source comprises at least one of: an enterprise; a data carrier; a user; a website; a biometric device; an electronic calendar; an electronic task list; a messaging application; and a seller.

39. A method according to claim 37, wherein at least one of the first data and the second data comprises: an application state; biometric data; computer usage data; telephone usage data; a position in a corporate application; a position in a standard application; and proximity data.

40. A method according to claim 37, wherein at least one of the first data and the second data comprise data related to an expected location.

41. A method according to claim 40, wherein the expected location is based on an electronic calendar.

42. A method according to claim 40, wherein the data related to the expected location includes data usable to contact a user at the expected location.

43. A method according to claim 40, wherein the data related to the expected location comprises real-time data.

44. A method according to claim 37, wherein at least one of the first data and the second data comprises at least one of: a location; a network protocol; a connection state; a bandwidth; a data latency period; a proximity; a request from a similar user; and a previous request from the user.

45. A method according to claim 44, wherein the location comprises at least one of: a cell ID; a fine location; and a proximity.

46. A method according to claim 45, wherein the proximity indicates a proximity to a data transmission service.

47. A method according to claim 37, wherein at least one of the first data and the second data comprises at least one of: user preferences; an emotional state; and data related to another user associated with the user.

48. A method according to claim 37, wherein at least one of the first data and the second data comprises at least one of: a Web cookie; a last known state; and data relating to similar users.

49. A method according to claim 37, wherein at least one of the first data and the second data comprises at least one of: skin response data, facial gesture data; and body temperature data.

50. A method according to claim 37, wherein at least one of the first data and the second data comprises at least one of: permanent I/O capability; temporary I/O capability; bandwidth; screen size; computer usage data; screen refresh rate; communication type; battery data; data relating to peripheral devices; an application state; and cookie information.

51. A method according to claim 37, wherein at least one of the first data and the second data comprises at least one of: an expected location; an expected communication capability; and expected travel time.

52. A method according to claim 37, wherein at least one of the first data and the second data comprises at least one of: a desired application; an expected location; a user expected to be contacted; and an expected purchase.

53. A method according to claim 37, wherein at least one of the first data and the second data comprises at least one of: natural language parsed content; an extracted expected location; a contact; an application state; and keywords.

54. A method according to claim 37, wherein at least one of the first data and the second data comprises at least one of: a last purchase; a last time of purchase; and a location.

55. A method according to claim 37, wherein at least one of the first data and the second data comprises data unrelated to the user.

56. A method according to claim 55, wherein the data unrelated to the user comprises at least one of: news; weather; traffic; cultural data; educational data; and arts data.

57. A method according to claim 37, wherein at least one of the first data and the second data comprises data associated with a second user associated with the user.

58. A method according to claim 37, wherein the service comprises advertising.

59. A method according to claim 37, wherein the service comprises an offer to sell.

60. A method according to claim 37, further comprising:
receiving an indication that the user does not want to receive services determined based on the first data and the second data.

61. A method according to claim 37, wherein the state comprises at least one of: busy; available; available hands free; available eyes free; available hands and eyes free; full; and emotional states.

62. A method according to claim 37, further comprising:
receiving a payment from the third party in exchange for the identification.

63. A method according to claim 37, wherein at least one of the first data and the second data is received via at least one of: a push protocol; a pull protocol; a broadcast; and a native observation.

64. A method according to claim 37, further comprising:
transmitting an alert based on the first data and the second data.

65. A method according to claim 64, wherein the alert indicates that a state of the user is different from a target state.

66. A method according to claim 37, wherein at least one of the first data and the second data is received via at least one of: a wireless protocol; a wired protocol; and a packet e-mail protocol.

67. A medium storing processor-executable process steps, the process steps comprising:
a step to receive first data associated with a user and owned by a first data owner;
a step to receive second data associated with the user and owned by a second data owner; and
a step to determine a service to provide to the user based on the first data and the second data.

68. A medium storing processor-executable process steps, the process steps comprising:
a step to receive first data associated with a user and owned by a first data owner;
a step to receive second data associated with the user and owned by a second data owner;
a step to determine a state based on the first data and the second data; and
a step to identify the user to a third party if the state corresponds to a target state.

69. An apparatus comprising:
a processor; and
a storage device in communication with the processor and storing instructions adapted to be executed by the processor to:
receive first data associated with a user and owned by a first data owner;
receive second data associated with the user and owned by a second data owner; and
determine a service to provide to the user based on the first data and the second data.

70. An apparatus comprising:
a processor; and
a storage device in communication with the processor and storing instructions adapted to be executed by the processor to:
receive first data associated with a user and owned by a first data owner;
receive second data associated with the user and owned by a second data owner;
determine a state based on the first data and the second data; and
identify the user to a third party if the state corresponds to a target state.

71. A system comprising:
a first data source providing first data associated with a user and owned by a first data owner;
a second data source providing second data associated with the user and owned by a second data owner; and
a server receiving the first data and the second data and determining a service to provide to the user based on the first data and the second data.

72. A system comprising:
a first data source providing first data associated with a user and owned by a first data owner;
a second data source providing second data associated with the user and owned by a second data owner; and
a server receiving the first data and the second data, determining a state based on the first data and the second data, and identifying the user to a third party if the state corresponds to a target state.
